(19) United States
(12) Patent Application Publication
(10) Pub. No.: US 2014/0223061 A1
(43) Pub. Date: Aug. 7, 2014

(54) SYSTEM AND DETERMINISTIC METHOD FOR SERVICING MSI INTERRUPTS USING DIRECT CACHE ACCESS

(71) Applicants: Keng Lai Yap, Bayan Baru (MY); Mee Sim Michelle Lai, Penang (MY)

(72) Inventors: Keng Lai Yap, Bayan Baru (MY); Mee Sim Michelle Lai, Penang (MY)

(21) Appl. No.: 13/995,027

(22) PCT Filed: Dec. 19, 2011
(86) PCT No.: PCT/US2011/065892

§ 371 Date: Jun. 17, 2013

(51) Int. Cl. G06F 13/24

(52) U.S. Cl. CPC G06F 13/24
USPC 710/263

(57) ABSTRACT

A system and method for creating a guaranteed MSI latency by coupling a coprocessor, which may be a dedicated agent, to the existing front side bus (“FSB”) in a processor (e.g., Intel® Atom™ processor) to handle deterministic interrupts. MSI interrupts may be automatically forwarded to the coprocessor using the existing Direct

Cache Access field. Users may control the handling time and methodology of MSI interrupts.

### FIELD OF THE INVENTION

The present invention pertains to handling of message signaled interrupts (“MSI”).

### DESCRIPTION OF RELATED ART

### Brief Background

For a processor whose architecture does not address deterministic interrupts for a real time system, MSI interrupts are very much dependent on the CPU (Central Processing Unit) processing time and users cannot control the MSI interrupt handling time. However, industrial applications require stringent and highly deterministic interrupt latency. With the existing Peripheral Component Interconnect (“PCI”)

Express architecture (e.g., PCI Express 3.0 Specification Revision 3.0, PCI-SIG, November 2010), MSI interrupt latency is not guaranteed.

Therefore, it would be desirable to provide a system and method for servicing MSI interrupts which allow users to control the handling time for these interrupts.

### BRIEF DESCRIPTION OF THE DRAWINGS

Embodiments are illustrated by way of example and not limitation in the Figures of the accompanying drawings:

FIG. 1 illustrates a block diagram of a system for automatic interrupt forwarding using direct cache access (“DCA”) according to one embodiment of the present invention;

FIG. 2 shows an MSI transaction layer packets (“TLPs”) header format according to the PCI Express specification;

FIG. 3a shows a memory write TLP with embedded DCA feature according to one embodiment of the present invention.

FIG. 3b is a flowchart of a method for automatically forwarding MSI interrupts to a dedicated external coprocessor connected to the front side bus (FSB) using DCA according to one embodiment of the present invention.

FIG. 4 is a block diagram of a system according to an embodiment of the present invention.

FIG. 5 illustrates a mechanism for automatic interrupt forwarding using DCA according to one embodiment of the present invention.

FIG. 6 is a flowchart of a method for automatically forwarding MSI interrupts to a dedicated external coprocessor connected to the FSB using DCA according to one embodiment of the present invention.

### DETAILED DESCRIPTION

The following description describes a system and method for servicing MSI interrupts using DCA within or in association with a processor, computer system, or other processing apparatus. In the following description, numerous specific details such as processing logic, processor types, micro-architectural conditions, events, enablement mechanisms, and the like are set forth in order to provide a more thorough understanding of embodiments of the present invention. It will be appreciated, however, by one skilled in the art that the invention may be practiced without such specific details. Additionally, some well known structures, circuits, and the like have not been shown in detail to avoid unnecessarily obscuring embodiments of the present invention.

Although the following embodiments are described with reference to a processor, other embodiments are applicable to other types of integrated circuits and logic devices. Similar techniques and teachings of embodiments of the present invention can be applied to other types of circuits or semiconductor devices that can benefit from higher pipeline throughput and improved performance. The teachings of embodiments of the present invention are applicable to any processor or machine that performs data manipulations. However, the present invention is not limited to processors or machines that perform 512 bit, 256 bit, 128 bit, 64 bit, 32 bit, or 16 bit data operations and can be applied to any processor and machine in which manipulation or management of data is performed. In addition, the following description provides examples, and the accompanying drawings show various examples for the purposes of illustration. However, these examples should not be construed in a limiting sense as they are merely intended to provide examples of embodiments of the present invention rather than to provide an exhaustive list of all possible implementations of embodiments of the present invention.

Although the below examples describe instruction handling and distribution in the context of execution units and logic circuits, other embodiments of the present invention can be accomplished by way of a data or instructions stored on a machine-readable, tangible medium, which when performed by a machine cause the machine to perform functions consistent with at least one embodiment of the invention. In one embodiment, functions associated with embodiments of the present invention are embodied in machine-executable instructions. The instructions can be used to cause a general-purpose or special-purpose processor that is programmed with the instructions to perform the steps of the present invention. Embodiments of the present invention may be provided as a computer program product or software which may include a machine or computer-readable medium having stored thereon instructions which may be used to program a computer (or other electronic devices) to perform one or more operations according to embodiments of the present invention. Alternatively, steps of embodiments of the present invention might be performed by specific hardware components that contain fixed-function logic for performing the steps, or by any combination of programmed computer components and fixed-function hardware components.

Embodiments of the present invention provide a system and method for creating a guaranteed MSI latency by coupling a coprocessor, which may be a dedicated agent, to the existing processor bus, such as a front side bus (“FSB”) in a processor (e.g., Intel® Atom™ processor) to handle deterministic interrupts. MSI interrupts may be automatically forwarded to the coprocessor using the existing Direct Cache Access field. Consequently, users may control the handling time and methodology of MSI interrupts.

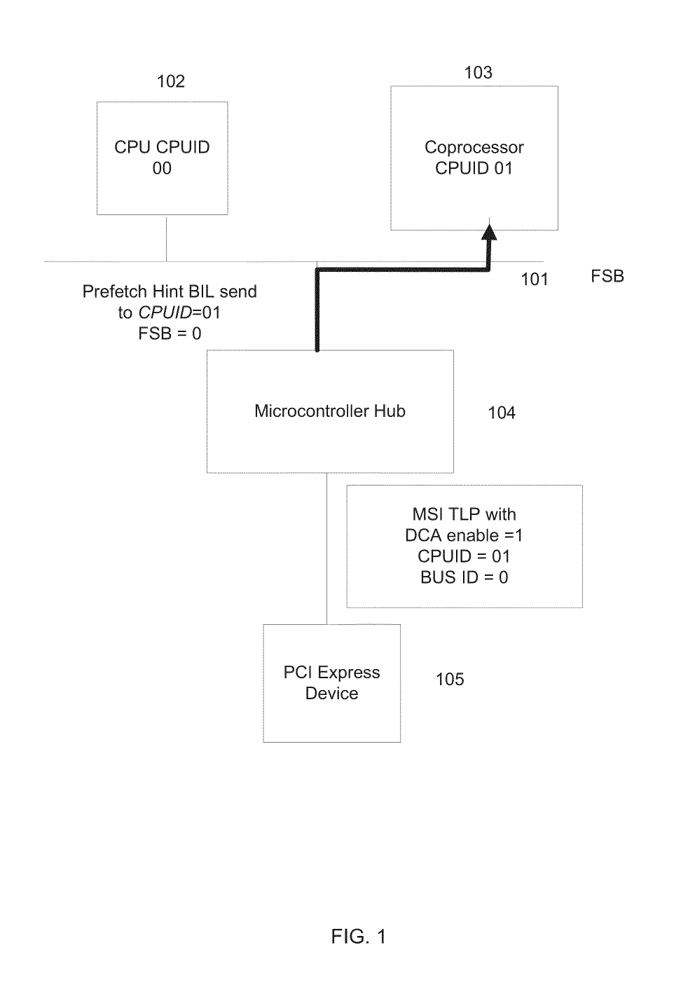

FIG. 1 illustrates a mechanism for automatic interrupt forwarding using DCA according to one embodiment of the present invention. As shown, a processing core such as CPU 102 may be attached to an FSB 101. The CPU 102 may be any type of central processing units, e.g., Intel® Atom™. Also attached to the FSB is an external coprocessor 103, which may be a dedicated agent for processing MSI interrupts. The coprocessor 103 may be a microcontroller, microprocessor or a field-programmable gate array (“FPGA”) which can be designed to handle MSI interrupt transactions.

In one embodiment, the coprocessor 103 may be assigned a CPUID (CPU Identification) and a BUSID (Bus Identification). A memory controller hub (“MCH”) 104 may receive a memory write transaction from a PCI Express device 105, and the existing logic of the MCH 104 may be used to identify the CPUID and BUSID of the external coprocessor 103.

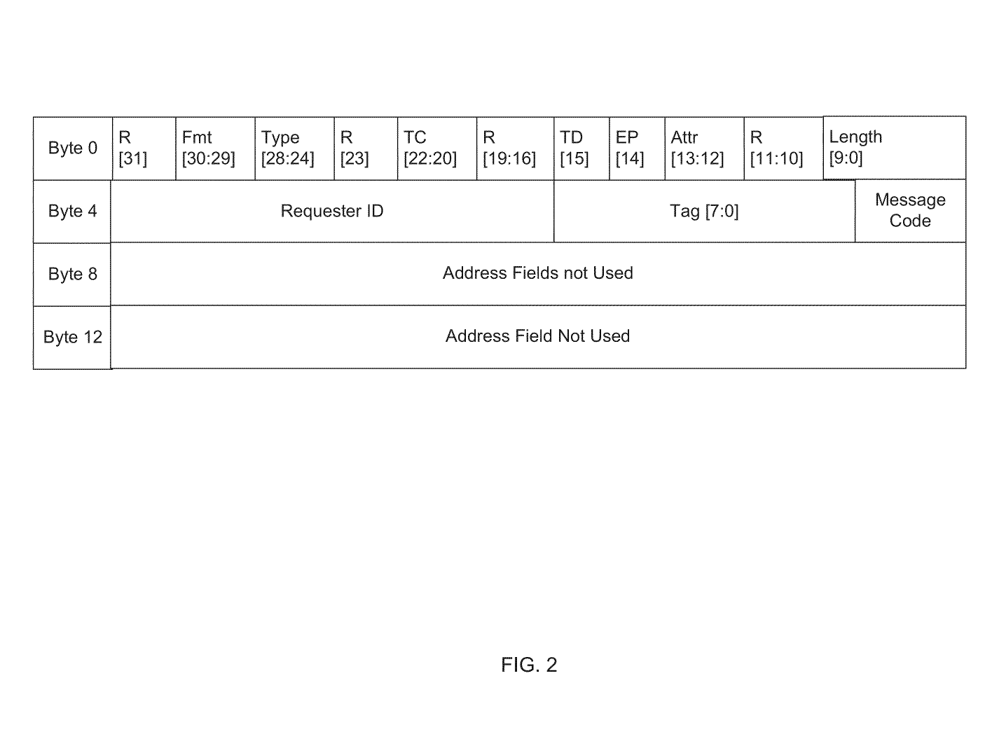

In existing MCH designs, DCA is used to improve efficiency of data transfer from I/O to memory. A DCA enabled MCH has the capability to hint a specific CPU to trigger hardware prefetch based on CPUID and BUSID embedded in the Tag field of the PCI Express memory write TLPs. FIG. 2 shows an MSI TLP header format according to the PCI Express specification. As stated in the PCI Express specification and shown in FIG. 2, the tag field in an MSI TLP header is unused and should be 0.

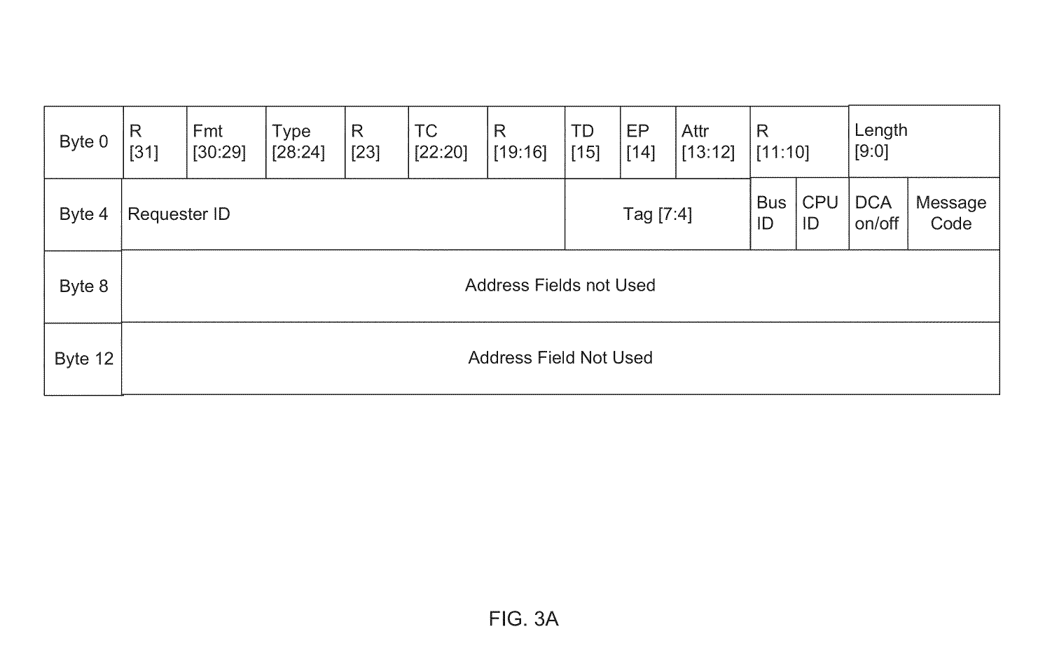

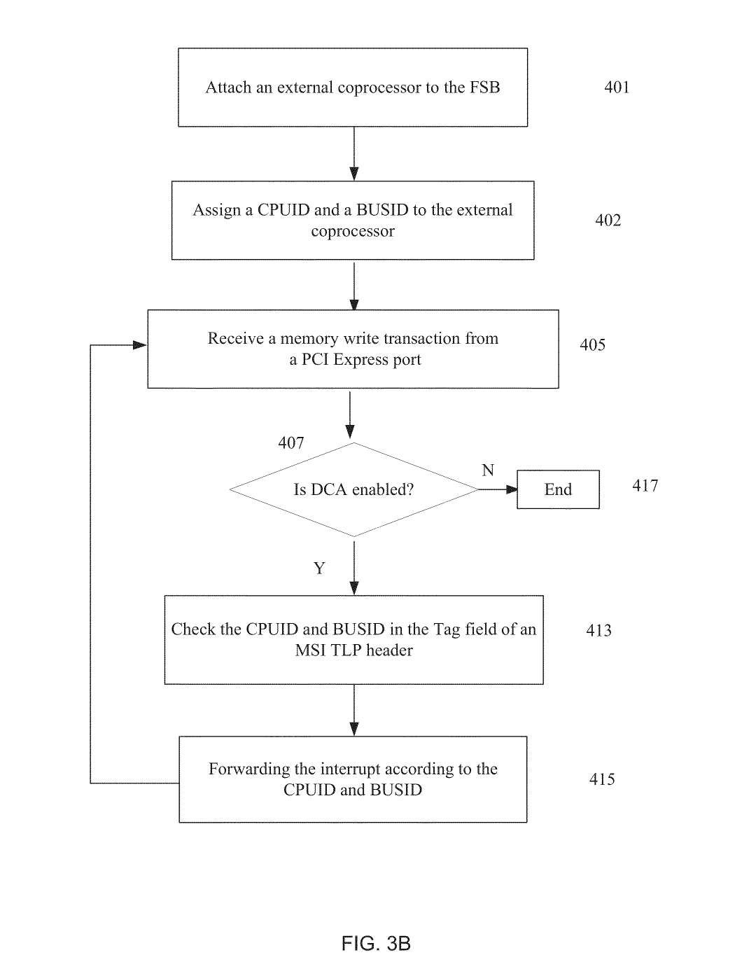

FIG. 3a shows a memory write TLP with the embedded DCA feature according to one embodiment of the present invention. As shown, the Tag field of the MSI TLP header may be used to identify the CPUID and BUSID of an external coprocessor with the DCA field enabled.

Table 1 is a description of DCA bits in FIG. 3a.

TABLE 1

| DCA bits | Description |
|---|---|
| DCA on/off (Tag[0]) | When this bit is set, PCI Express device |
| | requests MCH to send the MSI interrupt to |
| | a dedicated FSB agent. |
| CPUID (Tag[2:1]) | This is a 2 - bit encoding to identify where |
| | the MSI Interrupt should be routed to. |
| Bus ID (Tag[3]) | This bit defines which target FSB bus the |
| | specific coprocessor is attached to. |

In the mechanism in FIG. 1, the CPUID for the CPU 102 may be 01, and the CPUID for the external coprocessor 103 may be 10. Since there is only one FSB in this mechanism, the BUSID could be either 0 or 1.

FIG. 3b is a flowchart of a method for automatically forwarding MSI interrupts to a dedicated external coprocessor connected to the FSB using DCA according to one embodiment of the present invention.

At 401, the external coprocessor 103 may be attached to the FSB 101.

At 403, a CPUID and a BUSID may be assigned to the external coprocessor 103. In one embodiment, the external coprocessor 103's CPUID may be 10, and its BUSID may be 0, indicating that an MSI interrupt should be routed to the external coprocessor 103 via the FSB 101.

When the MCH 104 receives a memory write transaction from the PCI Express device 105 at 405, it may check for the Tag field of bits 0 to 3. At 407, the MCH 104 may check if bit 0 is set.

If yes, the MCH 104 determines that this is a DCA enabled transaction and the process may proceed to 413 to check CPUID and BUSID. Otherwise, the process may end (417).

At 415, the MCH 104 may trigger a hint to FSB with the CPUID and BUSID embedded in the transaction. In one embodiment, a BIL (Bus Invalidate Line)-hint transaction may be used. The BIL is in the FSB protocol and may be used for two purposes: to trigger the hardware prefetch in the CPU to fetch the data from the associated address in the memory and to invalidate a cacheline shared by two CPUs. In one embodiment, in the BIL-hint transaction, EXF[3]# may be used to specify a prefetch hint, DID[6:5]# may be used to specify the CPUID which may be “01” for the external coprocessor 103 and ATTR[6:5]# may be used to specify the BUSID which may be “0”. In other words, the BIL transaction on the FSB may involve the EXF[3]# hardware pin to generate the prefetch hint, DID[6:5]# pin to specify the CPUID and ATTR[6:5]# pin to specify the BUSID. This transaction may trigger the hardware prefetch to fetch the MSI interrupt vector/instruction from a memory so that the coprocessor 103 may get the information it needs to handle the interrupt.

The process may then return to 405.

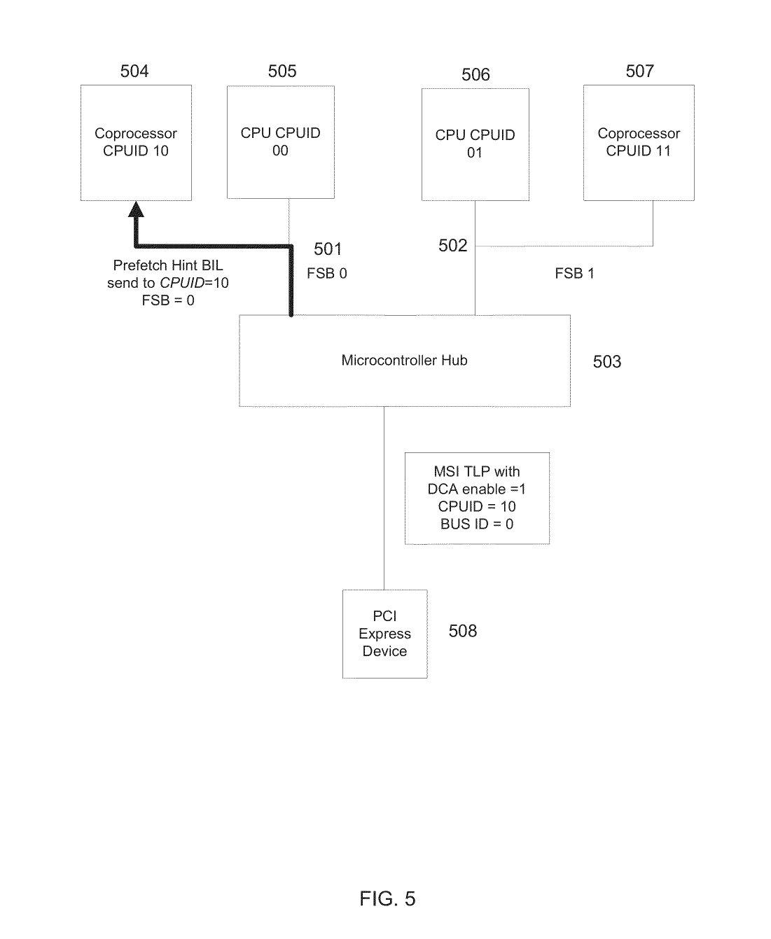

FIG. 5 illustrates a mechanism for automatic interrupt forwarding using

DCA according to one embodiment of the present invention. As shown, the mechanism 500 comprises two FSBs 501 and 502, two CPUs 505 and 506, and two external coprocessors 504 and 507. Specifically, FSBs 501 and 502 may be coupled to an MCH 503. The external coprocessor 504 and the CPU 505 may be attached to the FSB 501, and the CPU 506 and the external coprocessor 507 may be attached to the FSB 502. The MCH 503 may be coupled to a PCI Express device 508. The CPUs may be any type of central processing units, e.g., Intel® Atom™. The external coprocessors may be a microcontroller, microprocessor or a field-programmable gate array (“FPGA”) which can be designed to handle MSI interrupt transactions.

As shown in Table 1, each of FSBs 501 and 502 may be assigned a one bit BUSID, e.g., 0 for the FSB 501 and 1 for the FSB 502.

Each of the CPUs and the external coprocessors may be assigned a BUSID, e.g., 0 for the CPU 505 and the external coprocessor 504, and 1 for the CPU 506 and the external coprocessor 507.

Each of the CPUs 505 and 506 and external coprocessors 504 and 507 may be assigned a two bit CPUID, e.g., 00 for the CPU 505, 01 for the CPU 506, 10 for the external coprocessor 504 and 11 for the external coprocessor 507. Accordingly, interrupts may be forwarded to external coprocessors 505 or 507, or CPUs 504 or 506 via two different FSBs 501 and 502 respectively.

The existing logic of MCH 503 may be used to identify CPUIDs and BUSIDs.

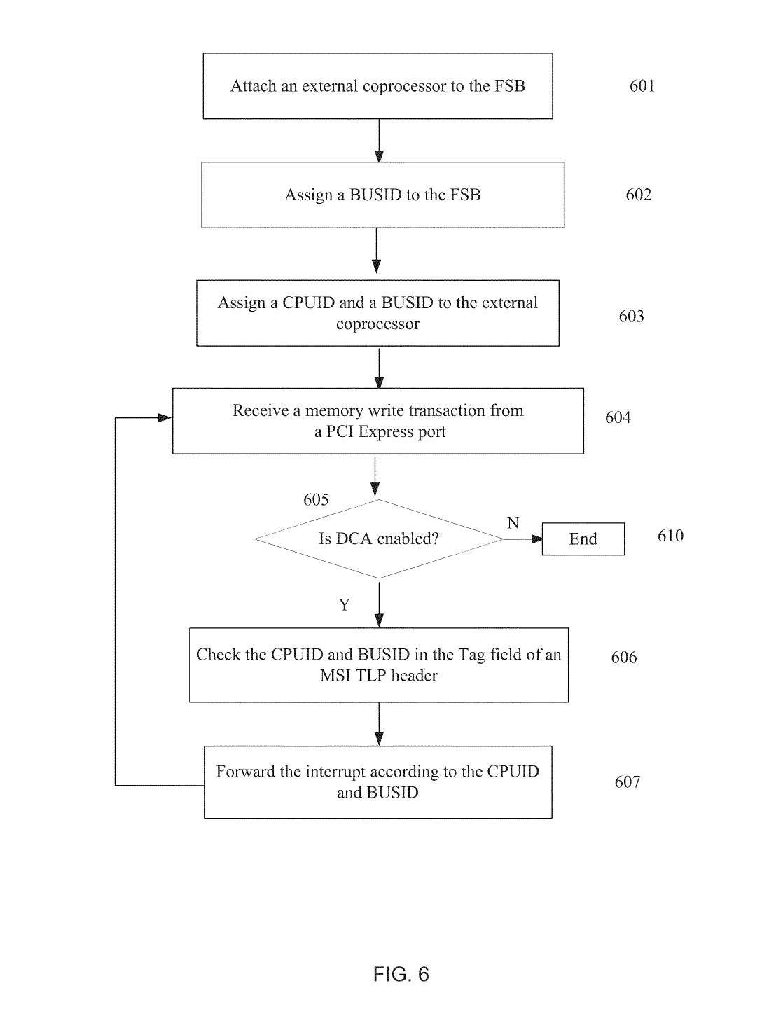

FIG. 6 is a flowchart of a method for automatically forwarding a MSI interrupt to a dedicated external coprocessor connected to the FSB using DCA according to one embodiment of the present invention.

At 601, the external coprocessor 504 may be attached to the FSB 501, and the external coprocessor 507 may be attached to the FSB 502.

At 602, a BUSID may be assigned to each of the FSBs, e.g., 0 for the FSB 501 and 1 for the FSB 502.

At 603, each of the CPUs and the external coprocessors may be assigned a BUSID and a CPUID. The BUSIDs may be, e.g., 0 for the CPU 505 and the external coprocessor 504, and 1 for the CPU 506 and the external coprocessor 507. The CPUIDs may be, e.g., 00 for the CPU 505, 01 for the CPU 506, 10 for the external coprocessor 504 and 11 for the external coprocessor 507.

When the MCH 503 receives a memory write transaction from the PCI Express device 508 at 604, it may check for the Tag field of bits 0 to 3. At 605, the MCH 503 may check if bit 0 is set.

If yes, the MCH 503 may determine that this is a DCA enabled transaction and the process may proceed to 606 to check CPUID and BUSID. Otherwise, the process may end (610).

At 607, the MCH may trigger a hint to FSB with the CPUID and BUSID embedded in the transaction. In one embodiment, in A BIL-hint transaction, EXF[3]# may be used to specify a prefetch hint, DID[6:5]# may be used to specify the CPUID which may be, e.g., 00 for the CPU 505, 01 for the CPU 506, 10 for the external coprocessor 504 and 11 for the external coprocessor 507, and ATTR[6:5]# may be used to specify the BUSID which may be 0 for the CPU 505 and the external coprocessor 504, and 1 for the CPU 506 and the external coprocessor 507.

The process may then return to 604.

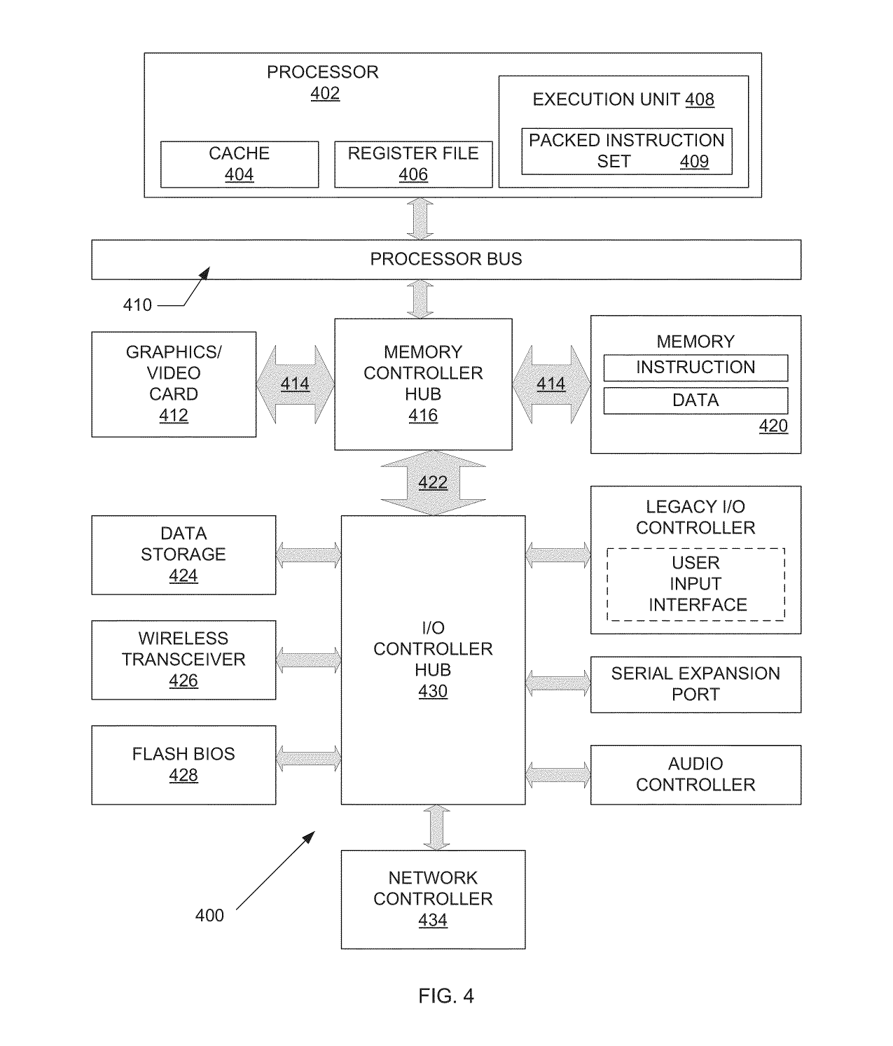

FIG. 4 is a block diagram of an exemplary computer system formed with a processor that includes execution units to execute instructions in accordance with one embodiment of the present invention. System 400 includes a component, such as a processor 402 to employ execution units including logic to perform algorithms for process data, in accordance with the present invention, such as in the embodiment described herein. System 400 is representative of processing systems based on the PENTIUM® III, PENTIUM® 4, Xeon™, Itanium®, XScale™ and/or StrongARM™ microprocessors available from Intel Corporation of Santa Clara, Calif., although other systems (including PCs having other microprocessors, engineering workstations, set-top boxes and the like) may also be used. In one embodiment, sample system 400 may execute a version of the WINDOWS™ operating system available from Microsoft

Corporation of Redmond, Washington, although other operating systems (UNIX and Linux for example), embedded software, and/or graphical user interfaces, may also be used. Thus, embodiments of the present invention are not limited to any specific combination of hardware circuitry and software.

Embodiments are not limited to computer systems. Alternative embodiments of the present invention can be used in other devices such as handheld devices and embedded applications. Some examples of handheld devices include cellular phones, Internet Protocol devices, digital cameras, personal digital assistants (PDAs), and handheld PCs. Embedded applications can include a micro controller, a digital signal processor (DSP), system on a chip, network computers (NetPC), set-top boxes, network hubs, wide area network (WAN) switches, or any other system that can perform one or more instructions in accordance with at least one embodiment.

FIG. 4 is a block diagram of a computer system 400 formed with a processor 402 that includes one or more execution units 408 to perform an algorithm to perform at least one instruction in accordance with one embodiment of the present invention. One embodiment may be described in the context of a single processor desktop or server system, but alternative embodiments can be included in a multiprocessor system. System 400 is an example of a ‘hub’ system architecture. The computer system 400 includes a processor 402 to process data signals. The processor 402 can be a complex instruction set computer (CISC) microprocessor, a reduced instruction set computing (RISC) microprocessor, a very long instruction word (VLIW) microprocessor, a processor implementing a combination of instruction sets, or any other processor device, such as a digital signal processor, for example. The processor 402 is coupled to a processor bus 410 that can transmit data signals between the processor 402 and other components in the system 400. The elements of system 400 perform their conventional functions that are well known to those familiar with the art.

In one embodiment, the processor 402 includes a Level 1 (L1) internal cache memory 404. Depending on the architecture, the processor 402 can have a single internal cache or multiple levels of internal cache. Alternatively, in another embodiment, the cache memory can reside external to the processor 402. Other embodiments can also include a combination of both internal and external caches depending on the particular implementation and needs. Register file 406 can store different types of data in various registers including integer registers, floating point registers, status registers, and instruction pointer register.

Execution unit 408, including logic to perform integer and floating point operations, also resides in the processor 402. The processor 402 also includes a microcode (ucode) ROM that stores microcode for certain macroinstructions. For one embodiment, execution unit 408 includes logic to handle a packed instruction set 409. By including the packed instruction set 409 in the instruction set of a general-purpose processor 402, along with associated circuitry to execute the instructions, the operations used by many multimedia applications may be performed using packed data in a general-purpose processor 402. Thus, many multimedia applications can be accelerated and executed more efficiently by using the full width of a processor's data bus for performing operations on packed data. This can eliminate the need to transfer smaller units of data across the processor's data bus to perform one or more operations one data element at a time.

Alternate embodiments of an execution unit 408 can also be used in micro controllers, embedded processors, graphics devices, DSPs, and other types of logic circuits. System 400 includes a memory 420. Memory 420 can be a dynamic random access memory (DRAM) device, a static random access memory (SRAM) device, flash memory device, or other memory device. Memory 420 can store instructions and/or data represented by data signals that can be executed by the processor 402.

A system logic chip 416 is coupled to the processor bus 410 and memory 420. The system logic chip 416 in the illustrated embodiment is a memory controller hub (MCH). The processor 402 can communicate to the MCH 416 via a processor bus 410. The MCH 416 provides a high bandwidth memory path 418 to memory 420 for instruction and data storage and for storage of graphics commands, data and textures. The MCH 416 is to direct data signals between the processor 402, memory 420, and other components in the system 400 and to bridge the data signals between processor bus 410, memory 420, and system I/O 422. In some embodiments, the system logic chip 416 can provide a graphics port for coupling to a graphics controller 412. The MCH 416 is coupled to memory 420 through a memory interface 418. The graphics card 412 is coupled to the MCH 416 through an Accelerated Graphics Port (AGP) interconnect 414.

System 400 uses a proprietary hub interface bus 422 to couple the MCH 416 to the I/O controller hub (ICH) 430. The ICH 430 provides direct connections to some I/O devices via a local I/O bus. The local I/O bus is a high-speed I/O bus for connecting peripherals to the memory 420, chipset, and processor 402. Some examples are the audio controller, firmware hub (flash BIOS) 428, wireless transceiver 426, data storage 424, legacy I/O controller containing user input and keyboard interfaces, a serial expansion port such as Universal Serial Bus (USB), and a network controller 434. The data storage device 424 can comprise a hard disk drive, a floppy disk drive, a CD-ROM device, a flash memory device, or other mass storage device.

For another embodiment of a system, an instruction in accordance with one embodiment can be used with a system on a chip. One embodiment of a system on a chip comprises of a processor and a memory. The memory for one such system is a flash memory. The flash memory can be located on the same die as the processor and other system components. Additionally, other logic blocks such as a memory controller or graphics controller can also be located on a system on a chip.

According to embodiments of the present invention, techniques for automatically forwarding MSI interrupts are disclosed. While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modifiable in arrangement and detail as facilitated by enabling technological advancements without departing from the principles of the present disclosure or the scope of the accompanying claims.

What is claimed is:

1. A system for servicing message signaled interrupts (“MSI”), comprising:
a first processor bus coupled to a microcontroller hub (MCH);
a first processing core coupled to the first processor bus; and
a first external coprocessor coupled to the first processor bus; wherein the first external coprocessor is a dedicated agent for handling MSIs.

2. The system of claim 1, wherein the first external coprocessor is selected from the group consisting of a microcontroller, a microprocessor and a field-programmable gate array (“FPGA”).

3. The system of claim 1, wherein the first processor bus is a front side bus (“FSB”) and the FSB is assigned with a BUSID.

4. The system of claim 3, wherein the first external coprocessor is assigned with a BUSID and a CPUID.

5. The system of claim 4, wherein the CPUID and BUSID are embedded in the Tag field of a PCI Express memory write transaction layer packet (“TLP”).

6. The system of claim 5, wherein the MCH is DCA enabled.

7. The system of claim 6, wherein the MCH triggers a hardware prefetch based on the CPUID and BUSID and forwards an interrupt accordingly.

8. The system of claim 1, further comprising:
a second processor bus coupled to the MCH;
a second processing core coupled to the second processor bus; and
a second external coprocessor coupled to the second processor bus.

9. The system of claim 8, wherein the second processor bus is a front side bus and is assigned with a BUSID.

10. The system of claim 8, wherein the second external coprocessor is assigned with a BUSID and a CPUID.

11. A method for servicing message signaled interrupts (“MSI”), comprising:
attaching a first external coprocessor to a front side bus (“FSB”); and
assigning a CPUID and a BUSID to the first external coprocessor,
wherein the FSB is coupled to a processing core, and
wherein the first external coprocessor is a dedicated agent for handling MSIs.

12. The method of claim 11, further comprising: assigning a CPUID and a BUSID to the processing core.

13. The method of claim 11, further comprising: assigning a BUSID to the FSB.

14. The method of claim 11, wherein the CPUID and BUSID are embedded in the Tag field of a PCI Express memory write transaction layer packet (“TLP”).

15. The method of claim 14, further comprising: indicating in the Tag field of the PCI Express memory write TLP whether direct cache access (“DCA”) is enabled.

16. The method of claim 15, further comprising: when receiving a memory write transaction from a PCI Express port, checking if DCA is enabled.

17. The method of claim 15, further comprising: if DCA is enabled, checking CPUID and BUSID embedded in the Tag field of the PCI Express memory write TLP.

18. The method of claim 17, further comprising: triggering a hint to the FSB with the CPUID and BUSID embedded in the Tag field of the PCI Express memory write TLP.

19. The method of claim 18, wherein a BIL (Bus Invalidate Line)-hint transaction may be used to trigger hardware prefetch to fetch MSI interrupt instruction.

20. The method of claim 18, further comprising: servicing the interrupt according to the information fetched.
